(19) United States
(12) Patent Application Publication
(10) Pub. No.: US 2007/0003740 A1
(43) Pub. Date: Jan. 4, 2007

(54) Promotional item and method of its manufacture

(76) Inventor: Webb Lowe, Los Angeles, CA (US)

Correspondence Address: CHRISTIE, PARKER & HALE, LLP, PO BOX 7068, PASADENA, CA, 91109-7068, US

(21) Appl. No.: 10/569,591

(22) PCT Filed: Aug. 30, 2004
(86) PCT No.: PCT/US04/28139

§ 371 Date: Feb. 23, 2006

Related U.S. Application Data
(60) Provisional application No. 60/498,836, filed on Aug. 29, 2003.

(51) Int. Cl. G09F 13/20; F21K 2/00

(52) U.S. Cl. 428/195.1; 428/690; 40/542; 250/462.1; 250/484.4

(57) ABSTRACT

An article of manufacture (10) comprises a photoluminescent decal (10) on which a corporate logo appears (14). In one embodiment, the corporate logo (10) is a photoluminescent surface (10) that appears on a non-photoluminescent background (12) or a non-photoluminescent surface (14) that appears on a photoluminescent background (16). In another embodiment, the logo (10) covers the entire surface of the film, leaving no background. Preferably, the decal (10) takes the form of a thin film that has an adhesive backing with a removable protective layer.

### BACKGROUND OF THE INVENTION

This invention relates to promotional articles of manufacture and, more particularly, to articles of manufacture adapted to convey memorable, multiple advertising impressions.

In the advertising world, a frequent goal is to convey multiple impressions of the advertised subject in a way that the target audience will recall the message. An effective way to accomplish this end is to embed the advertised subject into entertainment content or an everyday environment such as a home or business setting.

### SUMMARY OF THE INVENTION

According to the invention, an article of manufacture comprises a photoluminescent decal on which a corporate logo appears. In one embodiment, the corporate logo is a photoluminescent surface that appears on a non-photoluminescent background or a non-photoluminescent surface that appears on a photoluminescent background. In another embodiment, the logo covers the entire surface of the film. Preferably, the decal takes the form of a thin film that has an adhesive backing with a removable protective layer.

### BRIEF DESCRIPTION OF THE DRAWINGS

FIGS. 1 to 3 represent various decals impressed with corporate logos.

### DETAILED DESCRIPTION OF THE INVENTION

The invention comprises decals for promoting a corporate logo or design. In one embodiment, the term “corporate logo or design” refers to a corporate logo or design that is the subject of a United States trademark or service mark registration. In another embodiment, the term refers to any corporate logo or design used by a business to promote its goods and/or services.

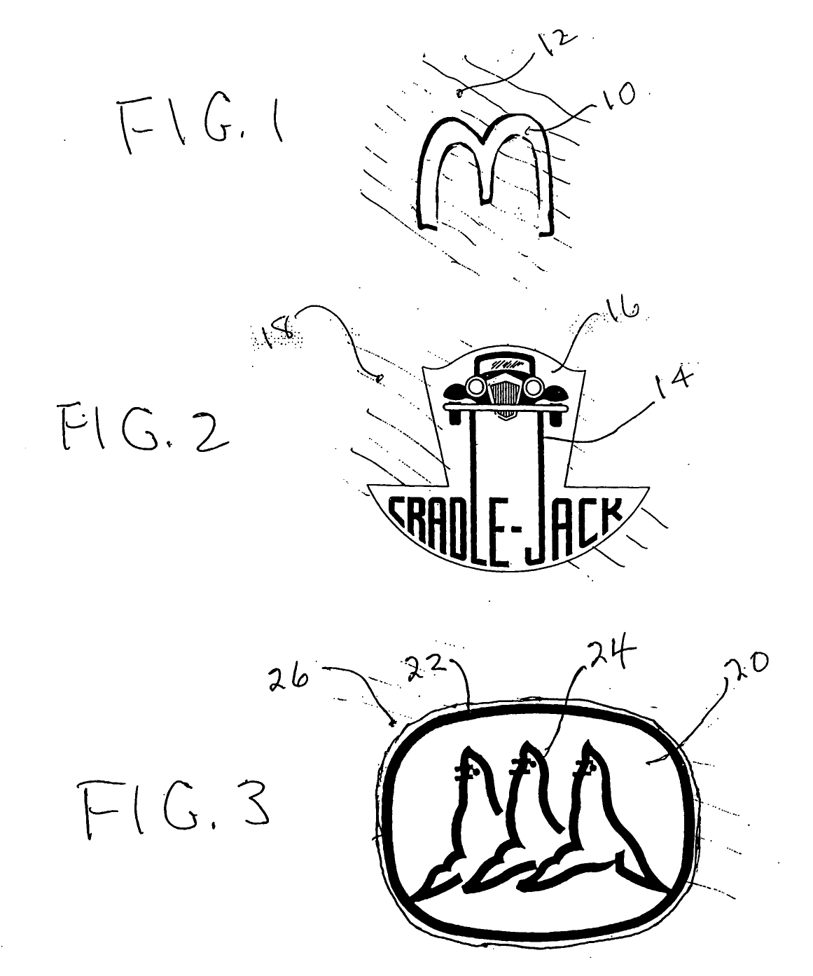

Preferably a decal on which a corporate logo or design appears is made from a photoluminescent film of the type shown on the attached brochure. The film is coated with an adhesive and a removable protective layer covers the adhesive. The film absorbs ambient light during the daylight hours and emits light from it surface during darkness. A number of embodiments of the invention are illustrated in FIGS. 1 to 3. In each case the background of the film on which the decal appears is represented by cross hatching.

In one embodiment the film 10 is cut in the shape or form of a corporate logo or design, as shown in FIG. 1, which is the McDonalds famous Golden Arches logo. Film 10 is shown on a cross-hatched background 12. No pattern is printed on film 10. The logo or design is represented only by the shape of the film 10. In other words, the logo covers the entire surface of the film, leaving no background.

In another embodiment shown in FIG. 2, a pattern 14 is printed on the surface of the film 16 to form the logo, either with black or colored ink. The film 16 is shown on a cross-hatched background 18. The surface of the film 16 not covered by the ink emits light, thereby leaving the areas covered by the ink unlighted.

In another embodiment shown in FIG. 3, ink could also be printed around the edge of the surface of the film 20 to form a frame 22 around a pattern 24. The film 20 is shown on a cross-hatched background 26. To further enhance the appearance of the decal, several patterns can be printed on the surface one on top of the other or side by side in different colors of ink.

Preferably, the decals are so designed that they can be produced with conventional printing equipment.

In use, after the protective layer is removed, the film is preferably placed on a surface of a room or outdoors to mark landmarks in the dark When the environment turns dark, the surface of the film emits light, thereby displaying the corporate logo, and the inked pattern and the cross-hatched background appear dark. By way of example, the film could be placed in a room on a light switch, a door knob, or a water glass, or could be placed outside at a step or driveway entrance. Each time an individual encounters the decal, the individual is exposed to another impression of the logo, thereby increasing the public awareness of the logo.

To manufacture the decals one or more dies are made in the shape of the outline of the logo and the die(s) is (are) used to punch out the decal from the film.

If a pattern is printed on the decals, the printing step precedes the punching step.

1. An article of manufacture comprising a photoluminescent decal on which a corporate logo appears.

2. The article of claim 2, in which the corporate logo is a photoluminescent surface that appears on a non-photoluminescent background.

3. The article of claim 2, in which the logo is a non-photoluminescent surface that appears on a photoluminescent background.

4. The article of claim 1, in which the decal is in the form of a thin film.

5. The article of claim 4, in which the film has an adhesive backing.

6. The article of claim 5, in which the adhesive backing has a removable protective layer

7. The article of claim 1, in which the logo occupies the entire surface of the decal.
